(19) United States
(12) Patent Application Publication
(10) Pub. No.: US 2026/0194642 A1
(43) Pub. Date: Jul. 9, 2026

(54) APPARATUS AND METHOD FOR PERFORMING RADAR-COMMUNICATION BY USING VIRTUAL RECEIVE ARRAY IN WIRELESS COMMUNICATION SYSTEM

(71) Applicants: LG ELECTRONICS INC., Seoul (KR); KOREA ADVANCED INSTITUTE OF SCIENCE AND TECHNOLOGY, Daejeon (KR)

(72) Inventors: Jihwan JANG, Seoul (KR); Kawon HAN, Daejeon (KR); Songcheol HONG, Daejeon (KR); Jaehoon CHUNG, Seoul (KR)

(73) Assignees: LG ELECTRONICS INC., Seoul (KR); KOREA ADVANCED INSTITUTE OF SCIENCE AND TECHNOLOGY, Daejeon (KR)

(21) Appl. No.: 19/131,895

(22) PCT Filed: Nov. 22, 2022
(86) PCT No.: PCT/KR2022/018508

§ 371 Date: May 21, 2025

(51) Int. Cl. G01S 13/02; G01S 7/02; H04B 7/0456

(52) U.S. Cl. CPC G01S 13/02; G01S 7/02; H04B 7/0456; G01S 2013/0245

(57) ABSTRACT

The present disclosure is for performing radar-communication by using frequency hopping in a wireless communication system, and an operating method of a communication apparatus may comprise the steps of: generating at least one codeword by encoding information bits; generating modulation symbols on the basis of the at least one codeword; transmitting signals including the modulation symbols; and when the signals are received after being reflected at an object, performing a radar operation by using the received signals. The radar operation may be performed on the basis of a virtual receive array formed by using signals transmitted through at least one subarray operating in a transmitting mode and received through the remaining at least one subarray operating in a receiving mode, from among a plurality of subarrays included in an antenna array, during a plurality of time intervals.

### CROSS-REFERENCE TO RELATED APPLICATION(S)

This application is the National Stage filing under 35 U.S.C. 371 of International Application No. PCT/KR2022/018508, filed on Nov. 22, 2022, the contents of which are all incorporated by reference herein in its entirety.

### TECHNICAL FIELD

The following description relates to a wireless communication system, and more particularly, to a device and method for performing radar-communication using virtual receive array in a wireless communication system

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

In the present disclosure, a device and method for effectively performing data communication and radar operations in a wireless communication system may be provided.

In the present disclosure, a device and method for performing radar operations using signals for data communication in a wireless communication system may be provided.

In the present disclosure, a device and method for performing radar operations without loss of channel capacity for data communication in a wireless communication system may be provided.

In the present disclosure, a device and method for performing radar operations using virtual receive array of signals in a wireless communication system may be provided.

In the present disclosure, a device and a method for utilizing a system architecture and an antenna array for wireless communication and radar sensing in a wireless communication system may be provided.

In the present disclosure, a device and a method for utilizing the same system hardware and antenna array for wireless communication and radar operations in a wireless communication system may be provided.

In the present disclosure, a device and a method for performing high-resolution radar sensing using limited hardware in a wireless communication system may be provided.

The technical objectives of the present disclosure are not limited to the matters described above, and other technical problems not mentioned herein may be considered by those skilled in the art to which the technical configuration of the present disclosure applies from the embodiments described hereinafter.

According to an embodiment of the present disclosure, a method of operating a communication device in a wireless communication system, the method may include: a transceiver including multiple transmitters and multiple receivers; and a processor connected to the transceiver, wherein the processor is configured to perform operations may include: generating at least one codeword by encoding information bits; generating modulation symbols based on the at least one codeword; transmitting signals including the modulation symbols; if receiving the signals after being reflected from an object, performing a radar operation using the received signals. For example, during multiple time intervals, the radar operation is transmitted through at least one sub-array operating in transmission mode among multiple sub-arrays included in an antenna array and performed based on a virtual reception array formed using signals received through the remaining at least one sub-array operating in reception mode.

According to an embodiment of the present disclosure, a communication device in a wireless communication system, the communication device may include: a transceiver including multiple transmitters and multiple receivers; and a processor connected to the transceiver, wherein the processor is configured to perform operations may include: generating at least one codeword by encoding information bits; generating modulation symbols based on the at least one codeword; transmitting signals including the modulation symbols; if receiving the signals after being reflected from an object, performing a radar operation using the received signals. For example, during multiple time intervals, the radar operation is transmitted through at least one sub-array operating in transmission mode among multiple sub-arrays included in an antenna array and performed based on a virtual reception array formed using signals received through the remaining at least one sub-array operating in reception mode.

According to an embodiment of the present disclosure, a communication device may include: at least one processor; a processor connected to the transceiver, at least one computer memory connected to the at least one processor and storing instructions that, based on being executed by the at least one processor, cause the device to perform operations, wherein the operations may include: a transceiver including multiple transmitters and multiple receivers; and a processor connected to the transceiver, wherein the processor is configured to perform operations may include: generating at least one codeword by encoding information bits; generating modulation symbols based on the at least one codeword; transmitting signals including the modulation symbols; if receiving the signals after being reflected from an object, performing a radar operation using the received signals. For example, during multiple time intervals, the radar operation is transmitted through at least one sub-array operating in transmission mode among multiple sub-arrays included in an antenna array and performed based on a virtual reception array formed using signals received through the remaining at least one sub-array operating in reception mode.

According to an embodiment of the present disclosure, a non-transitory computer-readable medium storing at least one instruction, comprising the at least one instruction being executable by a processor, wherein the at least one instruction is configured to perform operations may include: a transceiver including multiple transmitters and multiple receivers; and a processor connected to the transceiver, wherein the processor is configured to perform operations may include: generating at least one codeword by encoding information bits; generating modulation symbols based on the at least one codeword; transmitting signals including the modulation symbols; if receiving the signals after being reflected from an object, performing a radar operation using the received signals. For example, during multiple time intervals, the radar operation is transmitted through at least one sub-array operating in transmission mode among multiple sub-arrays included in an antenna array and performed based on a virtual reception array formed using signals received through the remaining at least one sub-array operating in reception mode.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, radar operations may be effectively performed using signals for data communication.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present disclosure.

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6th generation (6G) system applicable to the present disclosure.

FIG. 9 shows an electromagnetic spectrum applicable to the present disclosure.

FIG. 10 shows a THz communication method applicable to the present disclosure.

FIG. 11 shows a concept of radar-communication operation according to an embodiment of the present disclosure.

FIG. 12 shows a concept of multiple input multiple output (MIMO) radar according to an embodiment of the present disclosure.

FIG. 13 shows a functional structure of a device for forming a virtual array according to an embodiment of the present disclosure.

FIG. 14 shows an example of a virtual array formed using antennas shared in a time division duplex (TDD) scheme according to an embodiment of the present disclosure.

FIG. 15 shows another example of a virtual reception array formed using antennas shared in a TDD scheme according to an embodiment of the present disclosure.

FIG. 16 shows an example of a procedure for performing communication and radar operations according to an embodiment of the present disclosure.

FIG. 17 shows an example of a procedure for forming a virtual reception array according to an embodiment of the present disclosure.

FIGS. 18a to 18d show beam patterns for a virtual reception array according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

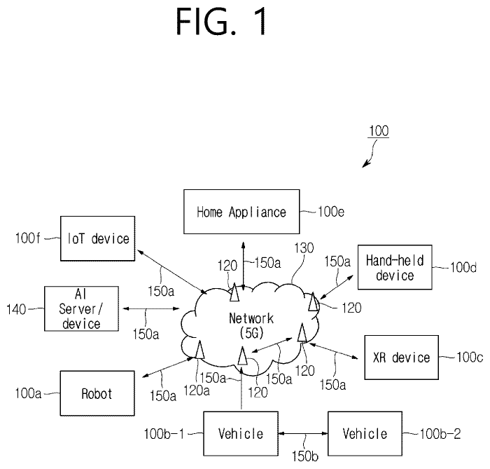

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100 a, vehicles 100 b-1 and 100 b-2, an extended reality (XR) device 100 c, a hand-held device 100 d, a home appliance 100 e, an Internet of Thing (IoT) device 100 f, and an artificial intelligence (AI) device/server 100 g. For example, the vehicles may include a vehicle having a wireless communication function, an autonomous vehicle, a vehicle capable of performing vehicle-to-vehicle communication, etc. The vehicles 100 b-1 and 100 b-2 may include an unmanned aerial vehicle (UAV) (e.g., a drone). The XR device 100 c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100 d may include a smartphone, a smart pad, a wearable device (e.g., a smart watch or smart glasses), a computer (e.g., a laptop), etc. The home appliance 100 e may include a TV, a refrigerator, a washing machine, etc. The IoT device 100 f may include a sensor, a smart meter, etc. For example, the base station 120 and the network 130 may be implemented by a wireless device, and a specific wireless device 120 a may operate as a base station/network node for another wireless device.

The wireless devices 100 a to 100 f may be connected to the network 130 through the base station 120. AI technology is applicable to the wireless devices 100 a to 100 f, and the wireless devices 100 a to 100 f may be connected to the AI server 100 g through the network 130. The network 130 may be configured using a 3G network, a 4G (e.g., LTE) network or a 5G (e.g., NR) network, etc. The wireless devices 100 a to 100 f may communicate with each other through the base station 120/the network 130 or perform direct communication (e.g., sidelink communication) without through the base station 120/the network 130. For example, the vehicles 100 b-1 and 100 b-2 may perform direct communication (e.g., vehicle to vehicle (V2V)/vehicle to everything (V2X) communication). In addition, the IoT device 100 f (e.g., a sensor) may perform direct communication with another IoT device (e.g., a sensor) or the other wireless devices 100 a to 100 f.

Wireless communications/connections 150 a, 150 b and 150 c may be established between the wireless devices 100 a to 100 f/the base station 120 and the base station 120/the base station 120. Here, wireless communication/connection may be established through various radio access technologies (e.g., 5G NR) such as uplink/downlink communication 150 a, sidelink communication 150 b (or D2D communication) or communication 150 c between base stations (e.g., relay, integrated access backhaul (IAB). The wireless device and the base station/wireless device or the base station and the base station may transmit/receive radio signals to/from each other through wireless communication/connection 150 a, 150 b and 150 c. For example, wireless communication/connection 150 a, 150 b and 150 c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

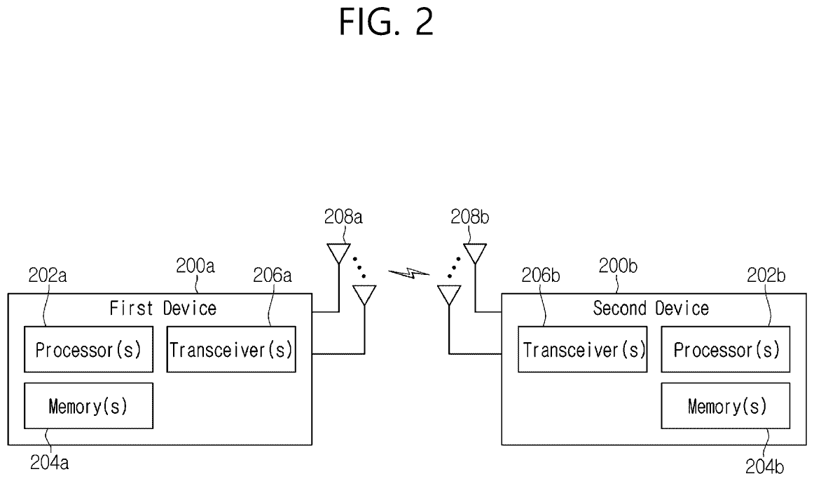

FIG. 2 shows an example of a wireless device applicable to the present disclosure.

Referring to FIG. 2, a first wireless device 200 a and a second wireless device 200 b may transmit and receive radio signals through various radio access technologies (e.g., LTE or NR). Here, (the first wireless device 200 a, the second wireless device 200 b) may correspond to (the wireless device 100 x, the base station 120) and/or (the wireless device 100 x, the wireless device 100 x) of FIG. 1.

The first wireless device 200 a may include one or more processors 202 a and one or more memories 204 a and may further include one or more transceivers 206 a and/or one or more antennas 208 a. The processor 202 a may be configured to control the memory 204 a and/or the transceiver 206 a and to implement descriptions, functions, procedures, proposals, methods and/or operational flowcharts disclosed herein. For example, the processor 202 a may process information in the memory 204 a to generate first information/signal and then transmit a radio signal including the first information/signal through the transceiver 206 a. In addition, the processor 202 a may receive a radio signal including second information/signal through the transceiver 206 a and then store information obtained from signal processing of the second information/signal in the memory 204 a. The memory 204 a may be coupled with the processor 202 a, and store a variety of information related to operation of the processor 202 a. For example, the memory 204 a may store software code including instructions for performing all or some of the processes controlled by the processor 202 a or performing the descriptions, functions, procedures, proposals, methods and/or operational flowcharts disclosed herein. Here, the processor 202 a and the memory 204 a may be part of a communication modem/circuit/chip designed to implement wireless communication technology (e.g., LTE or NR). The transceiver 206 a may be coupled with the processor 202 a to transmit and/or receive radio signals through one or more antennas 208 a. The transceiver 206 a may include a transmitter and/or a receiver. The transceiver 206 a may be used interchangeably with a radio frequency (RF) unit. In the present disclosure, the wireless device may refer to a communication modem/circuit/chip.

The second wireless device 200 b may include one or more processors 202 b and one or more memories 204 b and may further include one or more transceivers 206 b and/or one or more antennas 208 b. The processor 202 b may be configured to control the memory 204 b and/or the transceiver 206 b and to implement the descriptions, functions, procedures, proposals, methods and/or operational flowcharts disclosed herein. For example, the processor 202 b may process information in the memory 204 b to generate third information/signal and then transmit the third information/signal through the transceiver 206 b. In addition, the processor 202 b may receive a radio signal including fourth information/signal through the transceiver 206 b and then store information obtained from signal processing of the fourth information/signal in the memory 204 b. The memory 204 b may be coupled with the processor 202 b to store a variety of information related to operation of the processor 202 b. For example, the memory 204 b may store software code including instructions for performing all or some of the processes controlled by the processor 202 b or performing the descriptions, functions, procedures, proposals, methods and/or operational flowcharts disclosed herein. Herein, the processor 202 b and the memory 204 b may be part of a communication modem/circuit/chip designed to implement wireless communication technology (e.g., LTE or NR). The transceiver 206 b may be coupled with the processor 202 b to transmit and/or receive radio signals through one or more antennas 208 b. The transceiver 206 b may include a transmitter and/or a receiver. The transceiver 206 b may be used interchangeably with a radio frequency (RF) unit. In the present disclosure, the wireless device may refer to a communication modem/circuit/chip.

Hereinafter, hardware elements of the wireless devices 200 a and 200 b will be described in greater detail. Without being limited thereto, one or more protocol layers may be implemented by one or more processors 202 a and 202 b. For example, one or more processors 202 a and 202 b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202 a and 202 b may generate one or more protocol data units (PDUs) and/or one or more service data unit (SDU) according to the descriptions, functions, procedures, proposals, methods and/or operational flowcharts disclosed herein. One or more processors 202 a and 202 b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

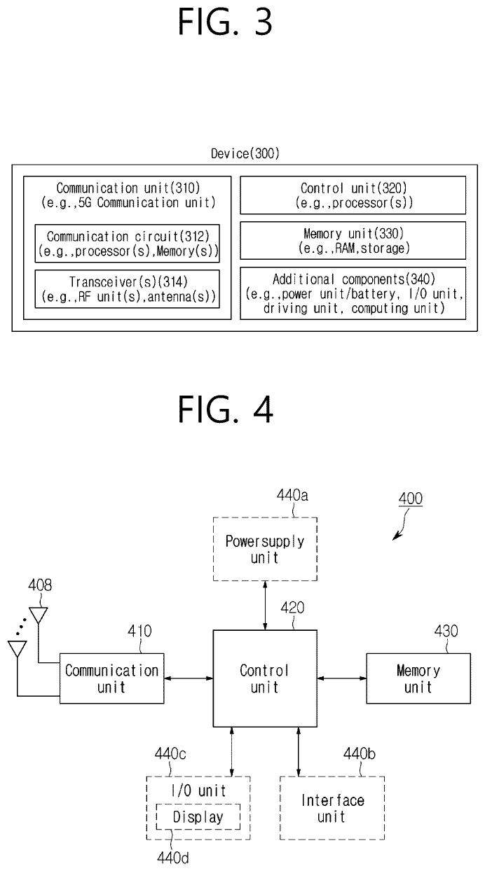

FIG. 3 shows another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

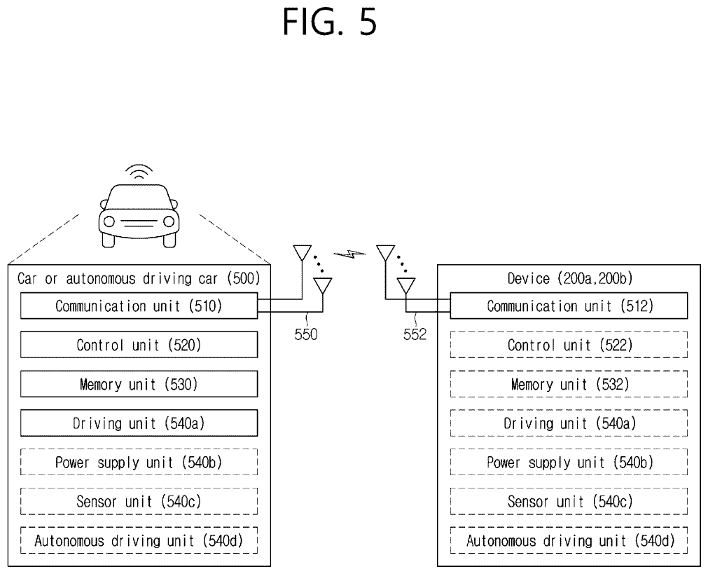

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

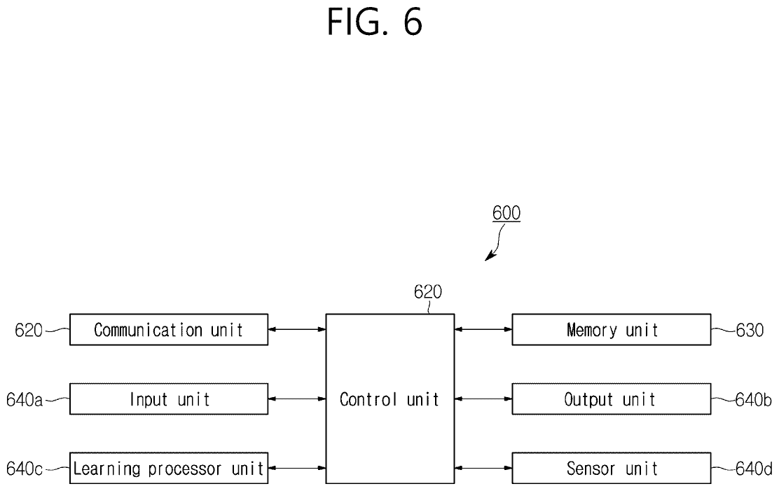

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

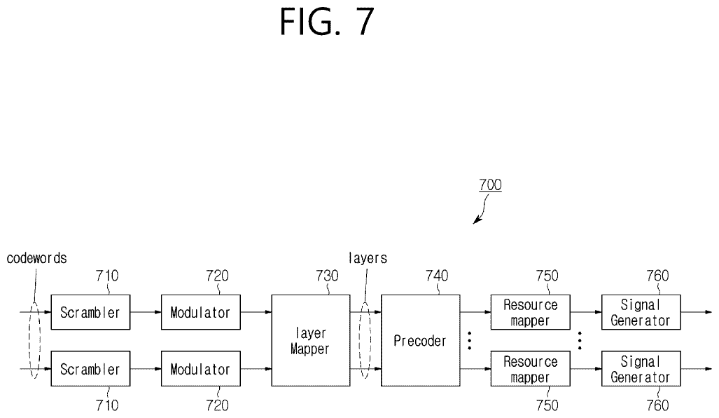

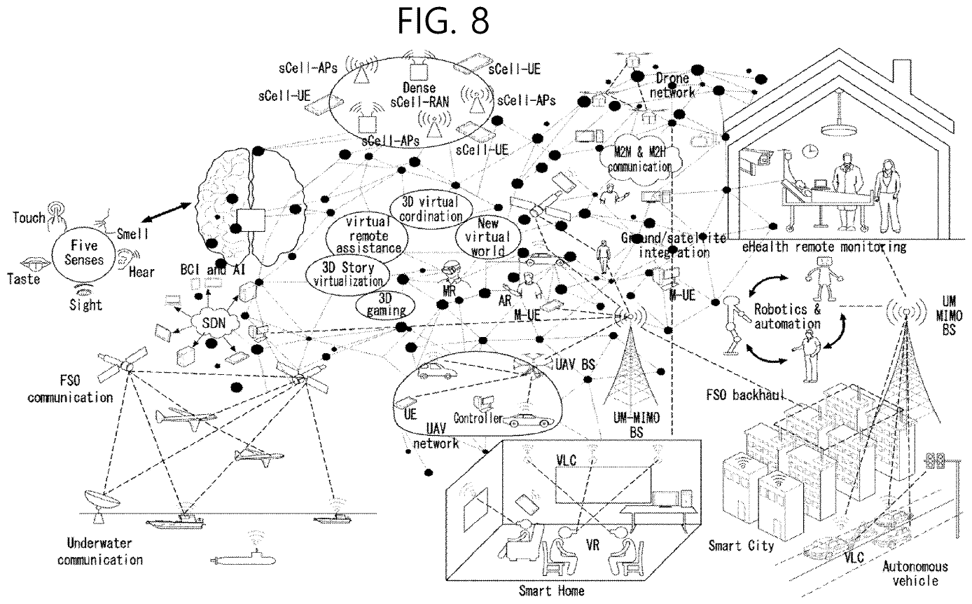

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |
| Mobility support | Up to 1000 | km/hr |

| | |
|---|---|
| Satellite integration | Fully |
| AI | Fully |
| Autonomous vehicle | Fully |
| XR | Fully |
| Haptic Communication | Fully |

At this time, the 6G system may have key actors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

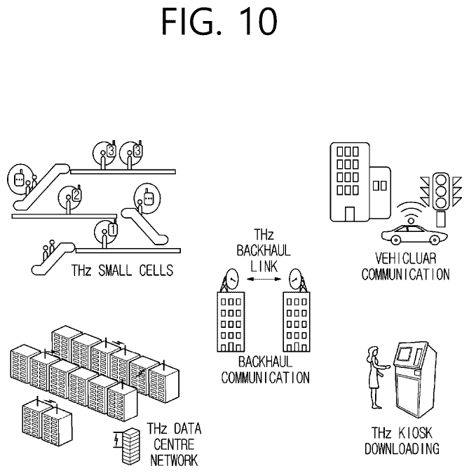

FIG. 10 shows an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel measurement and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

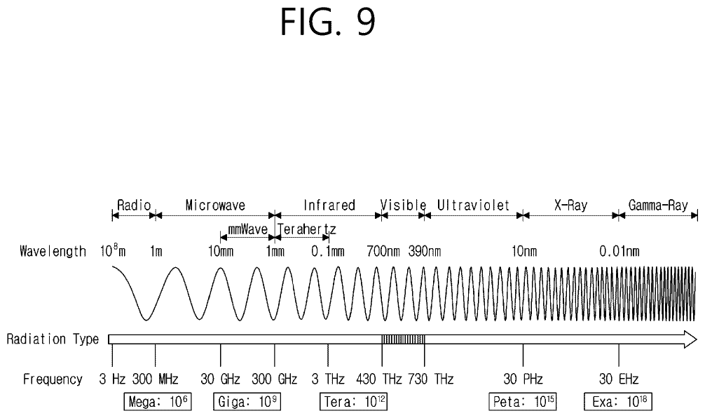

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RE.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### DETAILED EMBODIMENTS OF THE PRESENT DISCLOSURE

The present disclosure relates to radar-communication using a virtual receive array in a wireless communication system. Specifically, the present disclosure relates to techniques for performing radar operations using a virtual receive array while performing wireless communication and radar sensing with the same hardware. In particular, the present disclosure proposes various embodiments of radar-communication operations utilizing a time division duplex (TDD) scheme. The present disclosure may be used to build wireless radar-communication networks applicable to various existing communication systems, as well as systems for the 6th generation (6G) and beyond 6G.

Recently, radar-communication systems that simultaneously support radar and communication using the same hardware have been actively researched. As the frequency used for communication systems increases into the millimeter-wave range, the frequencies for communication and radar become similar to each other, and functions previously implemented in hardware are being replaced by signal processing methods. Radar-communication systems may be widely applied in intelligent transportation platforms, sensor networks, autonomous driving, etc., which require both radar sensing and communication links with other vehicles.

The current structures of radar and communication systems have limitations in simultaneously operating radar-communication. For communication, the Time Division Duplex (TDD) method may be used. TDD is a scheme where transmitting and receiving antennas are shared by switching between transmission and reception on the time axis. Utilizing the TDD method allows antennas to be shared. Consequently, the size of system modules may be reduced, and channel estimation for communication is simplified compared to cases where transmit and receive antennas are separated.

However, unlike communication, radar requires simultaneous transmission and reception, making the TDD method unsuitable for radar operation. While implementing radar using TDD is not impossible, certain detection algorithms require simultaneous transmission and reception. Additionally, reception downtime caused by transmit-receive switching can limit radar performance. Therefore, full-duplex operation is more suitable than TDD for radar applications. In other words, it is preferable for radar systems to operate in full duplex. In full-duplex MIMO radar or phased-subarray MIMO radar systems, antennas for transmitters and receivers are designed separately. However, this structure increases the size of RF system modules and requires channel estimation for both transmit and receive antennas during communication, making it unsuitable for radar-communication systems.

To address this issue, a method using a circulator to simultaneously utilize a single antenna for transmission and reception has been proposed. However, circulators exhibit isolation problems at higher operating frequencies, making this method also unsuitable for radar-communication integration.

Therefore, the present disclosure proposes a MIMO radar sensing technique suitable for radar-communication systems utilizing a TDD scheme, thereby reducing module size, simplifying channel estimation, and leveraging shared structures of transmit-receive antennas.

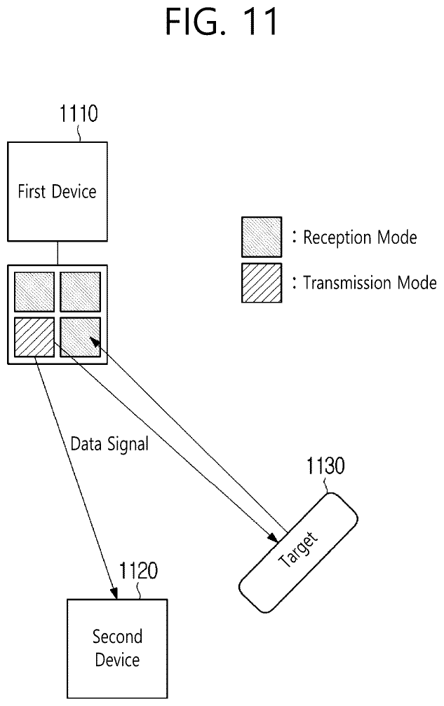

First, the concepts of radar and communication operations in a radar-communication system are as follows. FIG. 11 shows a concept of radar-communication operation according to an embodiment of the present disclosure. FIG. 11 exemplifies a scenario where a first device (1110) with radar capability communicates with a second device (1120) while sensing a target (1130).

Referring to FIG. 11, the first device (1110) transmits data signals using an antenna array. Here, the antenna array includes multiple sub-arrays, each capable of operating in transmission mode or reception mode. The data signal includes data and/or information intended to be transmitted to the second device (1120). The second device (1120) communicates with the first device (1110) by receiving the data signal. In other words, the data signal conveys data and/or information to the second device (1120).

In addition, the data signal may be reflected by the target (1130). The reflected signal from the target (1130) is received through at least one sub-array operating in reception mode of the first device (1110). In other words, the first device (1110) may receive the reflected signal corresponding to the data signal transmitted through at least one sub-array operating in transmission mode via at least one sub-array operating in reception mode. To facilitate this, the transmitter and receiver of the first device (1110) may operate simultaneously in full-duplex mode. The first device (1110) may perform radar operations to sense the target (1130) using the reflected signals.

As described above, the device (e.g., first device (1110)) according to various embodiments of the present disclosure may perform radar operations using data signals rather than signals specifically designed for radar sensing. Consequently, both communication and radar operations may be performed using the same signals. If necessary, additional processing may be performed on the data signals to use them as radar signals. In FIG. 11, the target device (1130) is described as a device distinct from the second device (1120) performing communication; however, depending on the situation, the second device (1120) may serve as the target device for radar operations.

The concept and operation principle of MIMO radar are as follows.

MIMO radar is composed of multiple transmit antennas and multiple receive antennas. A MIMO radar composed of Nₜ transmit antennas and Nᵣ receive antennas may provide the same performance as a radar using Nₜ×Nᵣ receive antennas. Therefore, MIMO radar may be effectively used to enhance the angular resolution of radar.

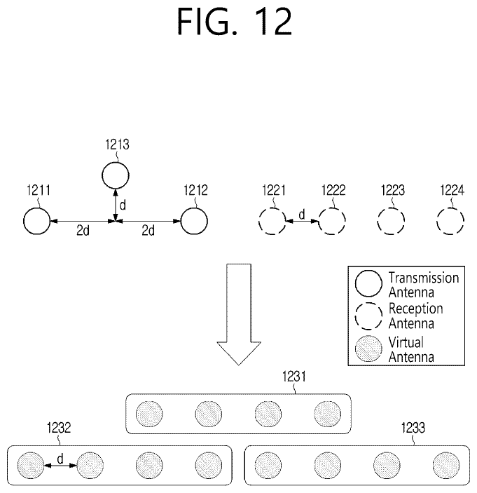

FIG. 12 shows a concept of MIMO radar according to an embodiment of the present disclosure. FIG. 12 exemplifies how a virtual antenna array for radar operation is formed in a MIMO radar device comprising three transmit antennas (1211 to 1213) and four receive antennas (1221 to 1224). Each of the transmit antennas (1211 to 1213) forms different phase arrays with respect to the four receive antennas (1221 to 1224). Because the distances between transmit antennas (1211 to 1213) cause additional phase shifts at the receive antennas (1221 to 1224), the phase arrays (1231 to 1233) formed by each transmit antenna (1211 to 1213) differ according to the distances between transmit antennas. Consequently, a 3×4 antenna configuration of MIMO radar forms a virtual receive antenna array consisting of 12 antenna elements.

Unlike phased-array radar that transmits a single waveform, MIMO radar may transmit multiple signals using multiple antennas, providing diversity in the transmitted waveforms. Due to this diversity, MIMO radar may offer superior performance in several aspects. Firstly, when MIMO radar transmits signals using Mt transmit antennas, the number of targets it may detect also increases by Mt times, as the virtual antenna aperture created by MIMO radar is effectively increased by Mt times. Furthermore, MIMO radar may utilize adaptive techniques, enabling improved resolution and interference signal suppression. When transmitted signals are independent, signals reflected from multiple targets also have linear independence. This property allows flexible application of suitable signal processing techniques for target localization.

Radar-communication operation using TDD is as follows.

Typical MIMO radar has a structure where transmit antennas and receive antennas are separated. This is because, at high frequencies, it is difficult to achieve sufficient isolation performance of circulators, making it challenging to implement a shared antenna structure for transmission and reception. However, the present disclosure proposes a method to perform radar operations by utilizing MIMO radar technology in a structure where antennas are shared for both transmission and reception.

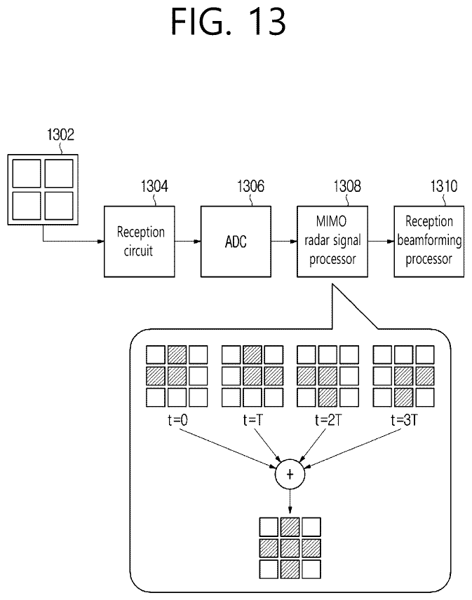

A functional structure of a device for forming a virtual array according to an embodiment of the present disclosure is shown. FIG. 13 shows a structure using four subarrays as an example. However, the structure of FIG. 13 may also be applied to structures using more subarrays.

Referring to FIG. 13, the device includes an antenna array (1302), a reception circuit (1304), an ADC (1306), a MIMO radar signal processing unit (1308), and a reception beamforming processing unit (1310).

The antenna array (1302) includes multiple subarrays. For example, the subarrays may be arranged in a 2×2 configuration. Each of the subarrays includes at least one antenna element. According to an embodiment, each subarray may be used in either transmission mode or reception mode. Specifically, among the multiple subarrays, some may operate in transmission mode, while the remaining subarrays operate in reception mode.

The reception circuit (1304) processes signals received through the antenna array (1302). For example, the reception circuit (1304) may include filters, amplifiers, and mixers, amplifying the received signals and converting them into intermediate frequency or baseband signals. Here, the reception circuit (1304) processes signals received through at least one subarray of the antenna array (1302) operating in reception mode. The ADC (1306) converts analog signals output from the reception circuit (1304) into digital signals.

MIMO radar signal processing unit (1308) forms a virtual receive array for MIMO radar operation based on signals received and processed over multiple time occasions. For example, the MIMO radar signal processing unit (1308) may place signals received through different combinations of subarrays at four time occasions such as t=0, T, 2T, and 3T into a virtual receive array, and may obtain signals received through the virtual receive array by combining the placed signals. Here, according to an embodiment, the aperture of the virtual receive array may be larger than the aperture of the antenna array (1302).

The receive beamforming processing device (1310) performs receive beamforming based on the virtual receive array formed by the MIMO radar signal processing unit (1308). In other words, the receive beamforming processing device (1310) may perform receive beamforming on signals generated according to the virtual receive array. That is, the receive beamforming processing device (1310) may perform receive beamforming on virtual signals obtained by combining signals received over multiple time occasions according to the virtual receive array, treating them as if received during a single time occasion. Accordingly, signals may be obtained for radar operation.

According to the structure as shown in FIG. 13, the virtual receive array may be formed. In the present disclosure, the virtual array of the MIMO structure may be determined by convolution between the transmit antennas and the receive antennas. For example, the result of determining the virtual array in a TDD-based radar-communication operation technology applied to a 2×2 subarray antenna structure may be represented as shown in [Table 2] below.

TABLE 2

| t = 0 | t = T | t = 2T | t = 3T | Total |
|---|---|---|---|---|
| $( \begin{matrix}1 & 0 \\ 0 & 0\end{matrix} ) * ( \begin{matrix}0 & 1 \\ 1 & 1\end{matrix} )$ | $( \begin{matrix}0 & 1 \\ 0 & 0\end{matrix} ) * ( \begin{matrix}1 & 0 \\ 1 & 1\end{matrix} )$ | $( \begin{matrix}0 & 0 \\ 1 & 0\end{matrix} ) * ( \begin{matrix}1 & 1 \\ 0 & 1\end{matrix} )$ | $( \begin{matrix}0 & 0 \\ 0 & 1\end{matrix} ) * ( \begin{matrix}1 & 1 \\ 1 & 0\end{matrix} )$ | $( \begin{matrix}0 & 2 & 0 \\ 2 & 4 & 2 \\ 0 & 2 & 0\end{matrix} )$ |
| $= ( \begin{matrix}0 & 1 & 0 \\ 1 & 1 & 0 \\ 0 & 0 & 0\end{matrix} )$ | $= ( \begin{matrix}0 & 1 & 0 \\ 0 & 1 & 1 \\ 0 & 0 & 0\end{matrix} )$ | $= ( \begin{matrix}0 & 0 & 0 \\ 1 & 1 & 0 \\ 0 & 1 & 0\end{matrix} )$ | $= ( \begin{matrix}0 & 0 & 0 \\ 0 & 1 & 1 \\ 0 & 1 & 0\end{matrix} )$ | |

By combining all the receive arrays formed at t=0 to 3T as shown in [Table 2], a final virtual receive array may be formed.

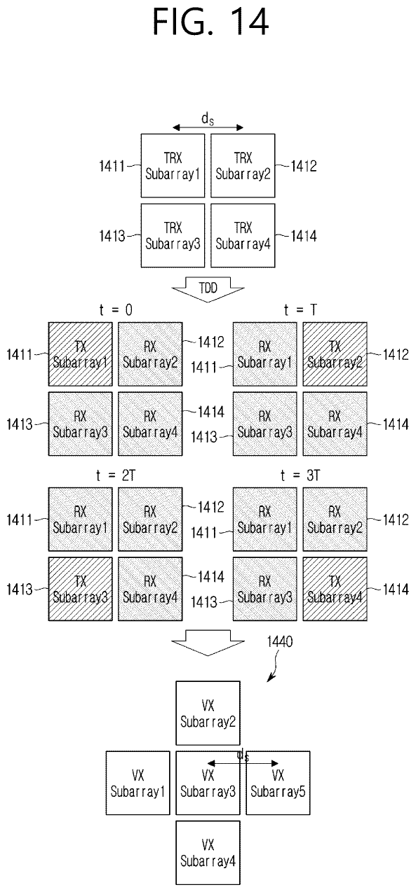

FIG. 14 shows an example of a virtual array formed using antennas shared in a TDD scheme according to an embodiment of the present disclosure. That is, FIG. 14 shows a technique that shares transmit and receive antennas in a TDD scheme using an antenna structure consisting of multiple subarrays. Referring to FIG. 14, the antenna array has a 2×2 subarray structure consisting of subarray 1 (1411), subarray 2 (1412), subarray 3 (1413), and subarray 4 (1414). Each of the subarrays (1411 to 1414) includes at least one antenna element and is connected to the front-end of transmitters and receivers including switches. Each of the subarrays (1411 to 1414) may include one antenna element, and in this case, each subarray (1411 to 1414) may be understood as a single antenna.

Applying the TDD method to a structure such as FIG. 14, each subarray (1411 to 1414) may be used as a transmit antenna depending on time. That is, during the radar pulse duration T, the device uses only one of the subarrays (1411 to 1414) for transmission and uses the remaining subarrays for reception. This operation is repeated for all transmitters. Specifically, at t=0, a signal is transmitted through subarray 1 (1411), and reflected signals are received through subarray 2 (1412), subarray 3 (1413), and subarray 4 (1414). Then, at t=T, a signal is transmitted through subarray 2 (1412), and reflected signals are received through subarray 1 (1411), subarray 3 (1413), and subarray 4 (1414). At t=2T, a signal is transmitted through subarray 3 (1413), and reflected signals are received through subarray 1 (1411), subarray 2 (1412), and subarray 4 (1414). At t=3T, a signal is transmitted through subarray 4 (1414), and reflected signals are received through subarray 1 (1411), subarray 2 (1412), and subarray 3 (1413). Subsequently, by combining the virtual receive arrays formed at the receivers, a final virtual receive array (1440) may be formed. The TDD operation of antenna subarrays for forming the virtual receive array (1440) as shown in FIG. 14 may be controlled as shown in [Table 3] below.

TABLE 3

| | t = 0 | t = T | t = 2T | t = 3T |
|---|---|---|---|---|
| Subarray #1 | TX | RX | RX | RX |
| | (downlink) | (Uplink) | (Uplink) | (Uplink) |
| Subarray #2 | RX | TX | RX | RX |
| | (Uplink) | (downlink) | (Uplink) | (Uplink) |
| Subarray #3 | RX | RX | TX | RX |
| | (Uplink) | (Uplink) | (downlink) | (Uplink) |
| Subarray #4 | RX | RX | RX | TX |
| | (Uplink) | (Uplink) | (Uplink) | (downlink) |

[Table 3] shows the operational states of subarrays considering the case where the subject performing communication-radar operation is a base station. As in [Table 2], each subarray is used in a TDD scheme. However, from the device's perspective, since transmission and reception are both performed using different subarrays at each time point, this may be understood as a full-duplex operation.

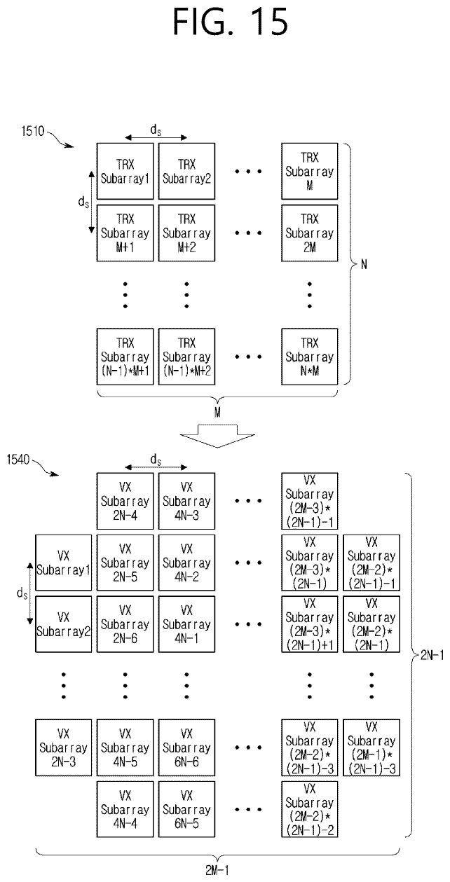

When generalizing the transmit-receive subarray array size as N×M, a virtual receive array may be formed as shown in FIG. 15. FIG. 15 shows another example of a virtual reception array formed using antennas shared in a TDD scheme according to an embodiment of the present disclosure. Referring to FIG. 15, from an N×M transmit-receive subarray array (1510), a (2N−1)×(2M−1) virtual receive array (1540) may be formed. That is, a virtual receive array approximately twice the size of the actual subarray array may be formed. In other words, as shown in FIG. 15, a MIMO radar utilizing N×M subarrays to form a (2N−1)×(2M−1) virtual receive array may be constructed.

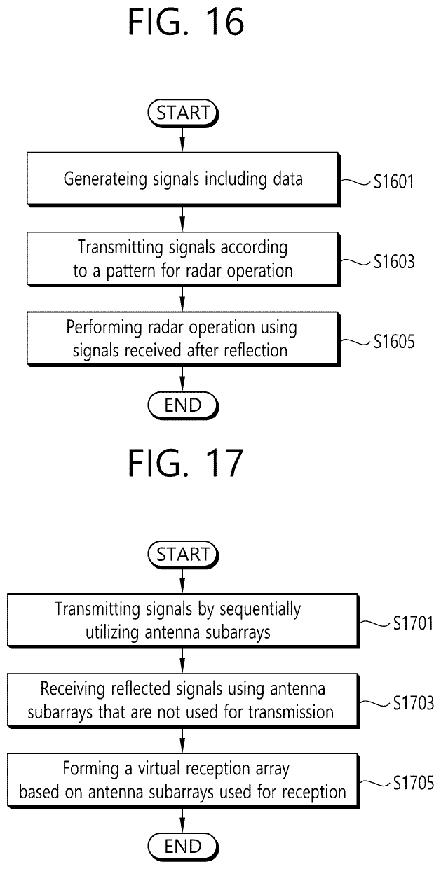

FIG. 16 shows an example of a procedure for performing communication and radar operations according to an embodiment of the present disclosure. FIG. 16 shows an operation method of a device (e.g., a base station or UE).

Referring to FIG. 16, in step S1601, the device generates signals containing data. The device generates signals that include data for communication with a counterpart device (e.g., UE, base station). For example, the device may generate at least one codeword by encoding information bits, perform scrambling on bits in the at least one codeword, and generate modulation symbols by modulating the scrambled bits. That is, the device may generate signals by performing at least one operation among encoding, scrambling, and modulation. At this time, the device may generate signals according to the coding rate and modulation scheme allocated by the base station. In other words, prior to signal generation, the device may perform scheduling or receive scheduling information (e.g., control signals).

At step S1603, the device transmits signals according to a pattern for radar operation. According to an embodiment, the pattern for radar operation may be defined such that multiple antenna subarrays are divided into multiple groups, and each group sequentially operates in a transmission mode. Here, at least one antenna subarray belonging to at least one remaining group other than the transmitting group operates in a receiving mode. Accordingly, at each time interval, signals transmitted via at least one antenna subarray belonging to one group may be reflected by an object and then received via at least one antenna subarray belonging to at least one other remaining group.

At step S1605, the device performs radar operations using signals received after reflection. That is, the device receives reflected signals generated when signals transmitted at step S1603 are reflected by an object, and may determine information regarding the object's position and movement using the received reflected signals. To achieve this, the device may form a virtual receive array using reflected signals received during different time intervals, and perform radar operations based on the virtual receive array. That is, the device forms a virtual receive array and arranges the received reflected signals according to the virtual receive arrays. For example, the device may form a virtual receive array as shown in FIG. 15.

According to the embodiment described with reference to FIG. 16, communication and radar operations may be performed using the same signals. Here, through radar operations, at least one among the distance to a target object, the relative angle to the target object, and the movement speed of the target object may be detected. The device may detect information related to the target object by applying various radar signal processing methods to the formed virtual receive array. Specifically, the device may determine at least one among the distance to the target object, the relative angle to the target object, and the movement speed of the target object, based on one of the intensity of the reflected signal, the angle of arrival of the reflected signal, and the channel value experienced by the reflected signal.

FIG. 17 shows an example of a procedure for forming a virtual reception array according to an embodiment of the present disclosure. FIG. 17 shows an operation method of a device (e.g., a base station or UE).

Referring to FIG. 17, at step S1701, the device transmits signals by sequentially utilizing antenna subarrays. The device includes a plurality of antenna subarrays, each connected to a transmitter and a receiver. Thus, each subarray may operate either in a transmission mode or a reception mode. Consequently, across multiple time intervals, the device transmits signals through at least one subarray, where the subarray operating in transmission mode may vary depending on the time interval. For instance, during multiple time intervals, each of the subarrays placed at the corners of a two-dimensional antenna array may operate in transmission mode at least once. In other words, the subarrays operating in transmission mode may include four subarrays selected to maximize distances from one another within the two-dimensional antenna array.

At step S1703, the device receives reflected signals using antenna subarrays that are not used for transmission. While some subarrays operate in transmission mode, at least one other subarray operates in reception mode. Accordingly, signals transmitted from subarrays operating in transmission mode reflect off an object and are received by the remaining subarrays operating in reception mode. Steps S1701 and S1703 are thus executed simultaneously within the same time intervals.

At step S1705, the device forms a virtual reception array based on the antenna subarrays used for reception. By forming this virtual reception array, signals received across multiple time intervals may be treated as if they were received during a single time interval. Consequently, the device achieves the effect of utilizing an antenna array larger than the actual physical size of the antenna subarrays. Specifically, the device arranges at least one subarray operating in reception mode during the same time interval based on the relative position of the subarray that operated in transmission mode. Subarrays operating in reception mode during different time intervals are arranged without overlap, thereby forming a virtual reception array larger than the actual antenna subarrays. For example, the device may form the virtual reception array based on the method as shown in Table 2.

By using the proposed technology, the advantages of MIMO radar described above can be fully utilized. Additionally, since transmit and receive antennas are shared, advantages related to hardware size and communication channel estimation arise, addressing issues associated with traditional MIMO structures that separate transmitters and receivers. Consequently, the proposed technology can improve the performance of radar-communication operations.

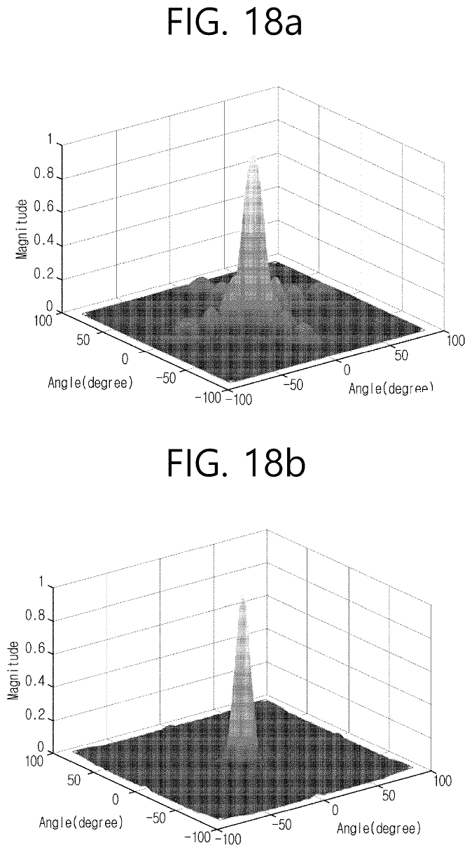

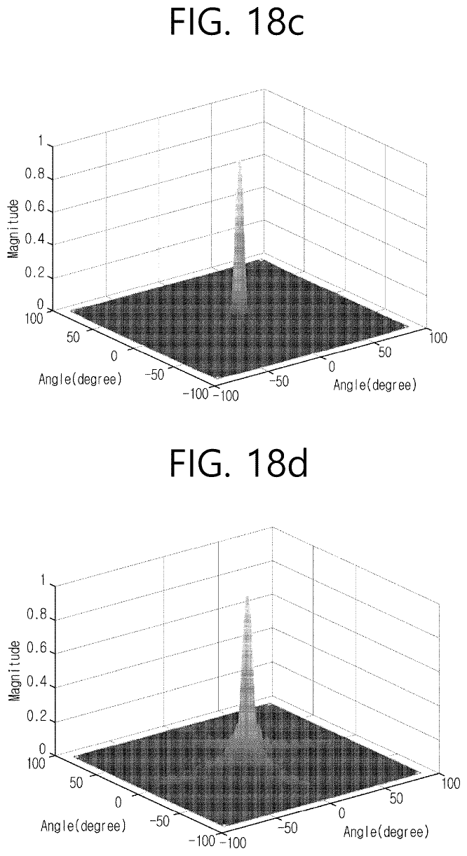

Examples of beam patterns formed using the previously described array structure are shown in FIGS. 18a through 18d. FIGS. 18a to 18d show beam patterns for a virtual reception array according to an embodiment of the present disclosure. FIGS. 18a through 18d show beams achievable with a 4×4 sub-array antenna array arranged in 2×2 and 4×4 configurations. FIG. 18a shows a beam pattern using hybrid beamforming with a 2×2 sub-array arrangement, and FIG. 18b shows the beam pattern of the virtual receive array formed through MIMO radar operation. FIG. 18c shows a beam pattern using hybrid beamforming with a 4×4 sub-array arrangement in which transmitters and receivers share antennas, and FIG. 18d shows the beam pattern of the virtual receive array formed through MIMO radar operation. Referring to FIGS. 18a and 18b, it is confirmed that the beam pattern of the virtual receive array is sharper than that of hybrid beamforming due to the approximately doubled aperture size compared to the physical antenna array. Similarly, referring to FIGS. 18c and 18d, the beam pattern of the virtual receive array is confirmed to be sharper than that of hybrid beamforming.

According to the various embodiments described above, the present disclosure enables improved angular resolution by utilizing a structure in which transmitters and receivers share antennas using switches, as used in existing communication systems. This facilitates the implementation of radar-communication integrated systems using existing TDD-based communication systems. Thus, the proposed technology enables simultaneous operation of high-performance sensing and communication in future 6G and wireless network environments. Furthermore, the proposed technology can be extended to various application areas, such as communication utilizing sensing and sensing utilizing communication.

According to various embodiments, a hybrid beamforming method, in which all sub-arrays simultaneously operate in transmit or receive mode to form a single beam, can also be supported. Thus, devices according to various embodiments of the present disclosure may support both hybrid and MIMO radar methods. However, operating in MIMO mode can yield higher resolution compared to when all sub-arrays operate simultaneously in transmit or receive mode. Additionally, for achieving higher angular resolution, the spacing between sub-arrays may be larger than the aperture of a single sub-array.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
generating at least one codeword by encoding information bits;
generating modulation symbols based on the at least one codeword;
transmitting signals including the modulation symbols;
performing, based on receiving the signal after being reflected from an object, a radar operation using the received signals;
wherein, during multiple time intervals, the radar operation is transmitted through at least one sub-array operating in transmission mode among multiple sub-arrays included in an antenna array and performed based on a virtual reception array formed using signals received through the remaining at least one sub-array operating in reception mode.

2. The method of claim 1,
wherein, in each of the multiple time intervals, the signals are transmitted through at least one sub-array operating in transmission mode among multiple sub-arrays, and received through remaining at least one sub-array operating in reception mode.

3. The method of claim 2,
wherein the at least one sub-array operating in transmission mode varies according to time intervals.

4. The method of claim 3,
wherein the at least one sub-array operating in transmission mode includes one sub-array in each of the time intervals.

5. The method of claim 1,
wherein the one sub-array is one of sub-arrays located at a corner of a two-dimensional antenna array.

6. The method of claim 1,
wherein spacing between the sub-arrays is wider than an aperture of one sub-array.

7. The method of claim 1,
wherein the virtual reception array is determined based on a convolution of a first array representing a position of at least one sub-array operating in the transmission mode and a second array representing a position of at least one sub-array operating in the reception mode in same time interval.

8. The method of claim 1,
wherein each of the sub-arrays includes at least one antenna element.

9. The method of claim 1,
wherein the virtual reception array is formed to have a size larger than the antenna array.

10. A communication comprising:
a transceiver including multiple transmitters and multiple receivers; and
a processor connected to the transceiver,
wherein the processor is configured to perform operations comprising:
generating at least one codeword by encoding information bits;
generating modulation symbols based on the at least one codeword;
transmitting signals including the modulation symbols;
performing, based on receiving the signals after being reflected from an object, a radar operation using the received signals;
wherein, during multiple time intervals, the radar operation is transmitted through at least one sub-array operating in transmission mode among multiple sub-arrays included in an antenna array and performed based on a virtual reception array formed using signals received through the remaining at least one sub-array operating in reception mode.

11. A communication device comprising:
at least one processor;
a processor connected to the transceiver,
at least one computer memory connected to the at least one processor and storing instructions that, based on being executed by the at least one processor, cause the device to perform operations,
wherein the operations comprising:
generating at least one codeword by encoding information bits;
generating modulation symbols based on the at least one codeword;
transmitting signals including the modulation symbols;
performing, based on receiving the signals after being reflected from an object, a radar operation using the received signals;
wherein, during multiple time intervals, the radar operation is transmitted through at least one sub-array operating in transmission mode among multiple sub-arrays included in an antenna array and performed based on a virtual reception array formed using signals received through the remaining at least one sub-array operating in reception mode.

12. (canceled)

13. The communication device of claim 10,
wherein, in each of the multiple time intervals, the signals are transmitted through at least one sub-array operating in transmission mode among multiple sub-arrays, and received through remaining at least one sub-array operating in reception mode.

14. The communication device of claim 13,
wherein the at least one sub-array operating in transmission mode varies according to time intervals.

15. The communication device of claim 14,
wherein the at least one sub-array operating in transmission mode includes one sub-array in each of the time intervals.

16. The communication device of claim 10,
wherein the one sub-array is one of sub-arrays located at a corner of a two-dimensional antenna array.

17. The communication device of claim 10,
wherein spacing between the sub-arrays is wider than an aperture of one sub-array.

18. The communication device of claim 10,
wherein the virtual reception array is determined based on a convolution of a first array representing a position of at least one sub-array operating in the transmission mode and a second array representing a position of at least one sub-array operating in the reception mode in same time interval.

19. The communication device of claim 10,
wherein each of the sub-arrays includes at least one antenna element.

20. The communication device of claim 10,
wherein the virtual reception array is formed to have a size larger than the antenna array.
